(19) United States
(12) Patent Application Publication
(10) Pub. No.: US 2007/0163342 A1
(43) Pub. Date: Jul. 19, 2007

(54) Device and method for damping the imbalance of a rotating part and dishwashing machine with such a device

(75) Inventors: Egbert Classen, Wertingen (DE); Helmut Jerg, Giengen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/640,513

(22) Filed: Dec. 15, 2006

(30) Foreign Application Priority Data
Dec. 27, 2005 (DE) 10 2005 062 470.7

(51) Int. Cl. B08B 3/00; G01M 1/00

(52) U.S. Cl. 73/458; 134/56 D

(57) ABSTRACT

A device and a method for damping the imbalance of a rotating part (7) are described, comprising a means (13) for determining at least one parameter of the imbalance during a rotational movement of the part and a means (20) for influencing the axis of rotation (15) of the rotating part (7) in such a manner that the axis of rotation (15) coincides with the axis of inertia (16) of the part (7), wherein at least one parameter is supplied as an input quantity to the means (20) for influencing to bring about a dynamic variation of the axis of rotation (15) with respect to the axis of inertia (16) of the rotating part.

The invention relates to a method and a device for damping the imbalance of a rotating part as well as a dishwashing machine with such a device.

We talk about imbalance in the case of rotating bodies whose mass is not uniformly distributed. Particularly, at high rotational speeds, an imbalance then results in vibrations and increased wear. Such imbalance is exhibited, for example, by electric motors in an electrical appliance such as a dishwashing machine or a washing machine, for example. As a result of the coupling of the drive motor to a housing of the electrical appliance, undesirable acoustic background noise occurs depending on the structure of the housing.

It is therefore the object of the present invention to provide a device and a method for damping the imbalance of a rotating part in such a manner that the advantages described above can be avoided. A further object is to provide a dishwashing machine, in particular a domestic dishwashing machine which exhibits reduced noise emission.

These objects are achieved by a device for damping the imbalance of a rotating part having the features of claim 1, with a dishwashing machine having the features of claim 12 as well as a method for damping the imbalance of a rotating part having the features of claim 14. Advantageous embodiments are obtained from each of the dependent claims.

The device according to the invention for damping the imbalance of a rotating part comprises a means for determining at least one parameter of the imbalance during a rotational movement of the part and a means for influencing the axis of rotation of the rotating part in such a manner that the axis of rotation coincides with the axis of inertia of the part. In this case, at least one parameter is supplied as an input quantity to the means for influencing to bring about a dynamic variation of the axis of rotation with respect to the axis of inertia of the rotating part.

The imbalance can be avoided or at least significantly reduced by the dynamic variation of the axis of rotation, i.e. a variation in real time, with respect to the axis of inertia of the rotating part. This can significantly reduce vibrations and reduce the emission of noise.

The means for determining the imbalance can determine the extent of the deviation of the axis of rotation from the axis of inertia of the axis of rotation and/or the direction of a deviation in a predetermined coordinate system as parameters. These two parameters are preferably supplied as input quantities to the means for influencing the axis of rotation of the rotating par which can then bring about a superposition of the axis of rotation and the inertia axis of the rotating part.

for this purpose, the means for influencing the axis of rotation comprises a plurality of actuators which can be triggered depending on the at least one parameter. The actuators thereby act on a stationary component relative to the rotating part and are for their part secured to a further fixed part.

In order to bring about a superposition of the axis of rotation and axis of inertia, it is advantageous if each of the plurality of actuators can be triggered separately depending on the at least one parameter. This means that specific input quantities for each of the actuators are determined by the means for determining the at least one parameter of the imbalance and supplied to said actuator.

The means for influencing the axis of rotation of the rotating part comprises at least two actuators. In this case, the actuators are arranged in a plane which is spanned by the predetermined coordinate system. The plane spanned by the predetermined coordinate system is preferably arranged perpendicular to the axis of inertia of the rotating part. In particular, the actuators are capable of displacing the axis of rotation of the rotating part within the plane spanned by the predetermined coordinate system to bring the axis of rotation into superposition with the axis of inertia of the rotating part.

Particularly simple triggering of the actuators and particularly efficient damping of imbalance is provided if the means for influencing the axis of rotation of the rotating part comprises three or four actuators. Preferably but not necessarily, the actuators are designed to produce a linear movement so that the axis of rotation of the rotating part can be brought to overlap with the axis of inertia.

In principle, the actuators can have an arbitrary structure. It is particularly preferable to use electroactive polymers as actuators in which one actuator comprises at least one transmission means each having two electrodes and a polymer electrically operatively connected thereto, in which a first section of the polymer can be deflected depending on an electric field generated by the two electrodes. Depending on which deflection of the first section of the polymer is required, it can be provided that a transmission member comprises a plurality of transmission means each having two electrodes and a polymer electrically operatively connected to these electrodes.

As a result of the free design of the polymer, electroactive polymers can be produced in almost any form. In this case, components to be driven mechanically, such as a motor, for example can be completely dispensed with. Triggering is effected merely by means of the voltage to be applied to the two electrodes. Electroactive polymers have the advantage that they exhibit rapid response behaviour when a corresponding voltage is applied.

Transmission means of the type described are known from the prior art and are described there as an electroactive polymer, dielectric elastomer, electroelastomer or EPAM. The structure and operating mode of such a transmission member is described, for example, in U.S. Pat. No. 6,545,384 B1. A plurality of exemplary embodiments as to how these can be used within the scope of the present invention can be deduced from US 2003/0 218 403 A1.

To amplify the deflection as well as to increase the force produced by the polymer, a second section of the polymer can be provided with a support means which supports the conversion of electrical energy into mechanical energy of the polymer. The support means can comprise any framework connected to the polymer or a spring.

The rotating part is preferably an electrically driven motor whose imbalance is prevented or reduced by the device according to the invention. Particular consideration is given to motors used in household appliances, such as dishwashing machines or washing machines, for example, in which the imbalance caused by a motor driving a circulating pump or a washing drum, for example, is manifest as increased unpleasant noise emission and vibration of the appliance.

A dishwashing machine according to the invention comprising a washing container a devices for washing crockery comprises a device of the type described above. In this case, the rotating part of the device is a drive motor of the circulating pump.

In the method according to the invention for damping the imbalance of a rotating part, at least one parameter of the imbalance is determined during a rotational movement of the part. One or more trigger values for a means for influencing the axis of rotation of the rotating part are determined from the at least one parameter so that when the means for influencing the axis of rotation is triggered, the axis of rotation coincides with the axis of inertia of the rotating part. The at least one trigger value is supplied to the means for influencing the axis of rotation of the rotating part to bring about a dynamic variation of the axis of rotation of the rotating part. No imbalance occurs at the rotating part during a rotation of the rotating part about the axis of inertia.

The extent of a deviation of the axis of rotation from the axis of inertia and/or the direction of a deviation in a predetermined coordinate system are determined as parameters of the imbalance.

A voltage value is determined from the at least one parameter value as a trigger value for the means for influencing the axis of rotation of the rotating part. This voltage value is used to trigger an actuator preferably embodied as an electroactive polymer.

A separate voltage value is determined for each actuator of the means for influencing the axis of rotation of the rotating part in order to be able to produce an overlap of the axis of rotation of the rotating part and the axis of inertia of the rotating part. The deflection or expansion or contraction produced by the actuator is determined by the magnitude of the voltage value.

To sum up, the invention consists in using an electroactive polymer as an actuator for damping the imbalance of a rotating part. As a result of the simple design structure, the simple triggering using a voltage to be applied to the electroactive polymer, a mechanical force which can be achieved by the free shaping of the electroactive polymer, imbalance of a rotating part detected by a sensor can be prevented or at least substantially reduced in real time by triggering the actuators.

The invention is explained in detail hereinafter with reference to the figures. In the figures:

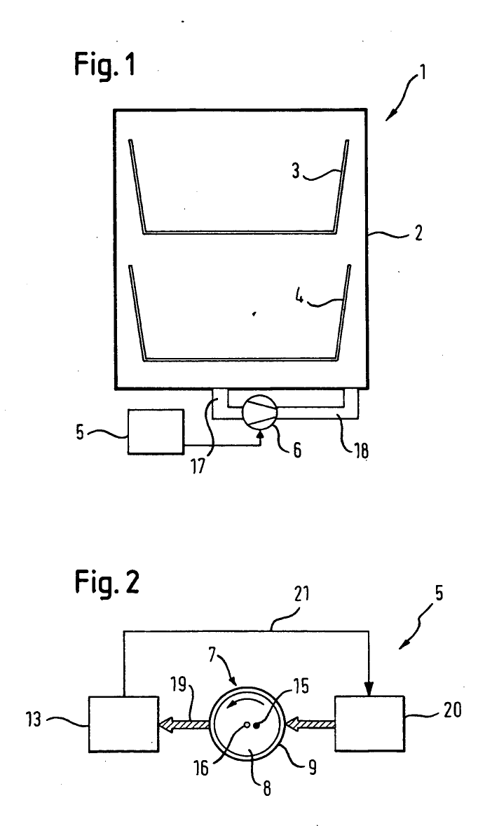

FIG. 1 shows a dishwashing machine according to the invention with a device for damping the imbalance of a rotating part,

FIG. 2 shows a schematic diagram of a device according to the invention for damping the imbalance of a rotating part;

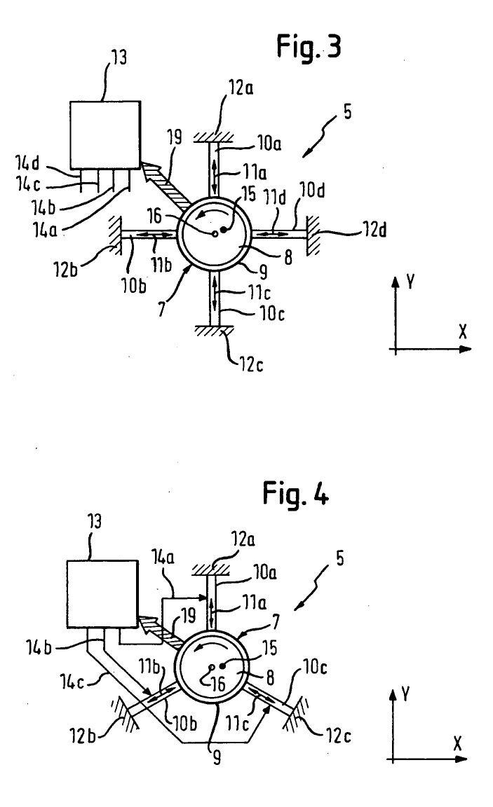

FIG. 3 shows a first exemplary embodiment of the device according to the invention for damping the imbalance of an electrically driven motor and

FIG. 4 shows a second exemplary embodiment of the device according to the invention for damping the imbalance of an electrically driven motor.

The dishwashing machine 1 shown schematically in FIG. 1 comprises in a known manner a washing container 2 and devices for washing crockery which is not shown. Spray devices not shown are assigned to the crockery baskets 3, 4 in a known fashion and act upon the crockery arranged in the crockery baskets 3, 4 with washing solution. The washing solution collecting at the bottom of the washing container of the dishwashing machine 1 is fed via a line 17 to a (circulating) pump 6 which feeds this to the spray devices via a line 18. The pump 6 is driven by an electric motor not shown in FIG. 1 which, without further measures, exhibits imbalance during its operation as a result of its design. According to the invention, a device 5 for damping imbalance is assigned to the pump 6, i.e. more accurately to the motor driving it.

FIG. 2 is a schematic diagram showing the structure of a device 5 according to the invention for damping the imbalance of a rotating part. The rotating part is formed, for example, by an electric motor 7 for driving the pump 6 of the dishwashing machine from FIG. 1. The motor 7 comprises in a known manner a rotatable rotor 8 in a fixed stator 9. The imbalance which occurs during operation of the motor 7 or the pump is detected by a sensor device 13.

This sensor detects the extent of any deviation of an axis of rotation 15 or a principal axis of inertia 16 of the motor 7 as a parameter 19. The sensor device 13 evaluates the parameter 19 and determines from this trigger values 21 which the sensor device 13 transmits to the means 20 for influencing the axis of rotation 15. The means for influencing the axis of rotation 15 uses the trigger values 21 as input quantities in order to bring about a dynamic variation of the axis of rotation 15 of the principal axis of inertia 16. In other words, the axis of rotation 15 and the principal axis of inertia 16 are brought into congruence with one another by the means 20.

FIGS. 3 and 4 show two exemplary embodiments of the device 5 for damping imbalance. In this case, the means 20 for influencing the axis of rotation 15 each comprises electroactive polymers as actuators. The actuators (10a, 10b, 10c, 10d) can also preferably comprise spindles driven by an electrical motor (not shown).

In the exemplary embodiment according to FIG. 3, four actuators 10a, 10b, 10c, 10d are provided, these being arranged in a plane spanned by an x-y coordinate system in the x and y direction. The actuators 10a, 10b, 10c, 10d each comprise at least one transmission means each having two electrodes and a polymer electrically operatively connected thereto, in which one section of the polymer can be deflected depending on an electric field generated by the electrodes. A voltage is applied between the two electrodes which results in a deflection (this can be an expansion or a contraction of the polymer) of the polymer.

According to the exemplary embodiment of the device in FIG. 3, the deflection of the polymer is longitudinal, the respective direction of motion being indicated by arrows characterized by the reference numerals 11a, 11b, 11c, 11d. The actuators 10a, 10b, 10c, 10d are each affixed to an allocated housing component 12a, 12b, 12c, 12d, e.g. the washing container 2 of the dishwashing machine 1. The other end of a respective actuator 10a, 10b, 10c, 10d is mechanically operatively connected to the motor 7, more precisely its stator 9. By applying a respective voltage to the actuators 10a, 10b, 10c, 10d, these can increase or reduce their length whereby the axis of rotation 15 can be varied. As a result, forces induced by the imbalance, for example, can be compensated by the counteracting forces produced by the actuators 10a, 10b, 10c, 10d. This is carried out according to the angle of rotation. The corresponding control signals are transmitted from the sensor device 13 as control signals 14a, 14b, 14c, 14d to the actuators 10a, 10b, 10c, 10d. This is merely indicated in FIG. 4 for the sake of clarity. The control signals in this case are voltage signals. A description of the operating mode of the actuators can be deduced for example from U.S. Pat. No. 6,545,384 B1.

The exemplary embodiment shown in FIG. 4 differs from the exemplary embodiment shown in FIG. 3 in that instead of four actuators, only three actuators 10a, 10b, 10care shown which, for example, are also arranged in the plane spanned by the x-y coordinate system, the actuators 10a, 10b, 10c, 10deach having the same angle with respect to one another.

The device according to the invention can be used to compensate dynamically, i.e. in real time, for imbalances which occur at rotating parts. This is carried out using electroactive polymers which exhibit a mechanical deflection when an electric field is applied. By providing a plurality of actuators it is possible to make the axis of rotation of the rotating part coincide with the principal axis of inertia and thereby prevent or reduce the imbalance. This results in reduced noise emission.

### REFERENCE LIST

1 Dishwashing machine

2 Washing container

3 Crockery basket

4 Crockery basket

5 Device for damping imbalance

6 Pump

7 Motor

8 Rotor

9 Stator

10a, . . . , 10d Actuator

11a, . . . , 11d Direction of movement of the actuator

12a, . . . , 12d Housing component

13 Sensor device

14a, . . . , 14d Control signal

15 Axis of rotation

16 Axis of inertia

17 Line

18 Line

19 Parameter

20 Means for influencing the centre of gravity

21 Trigger values.

1-18. (canceled)

19. A device for damping the imbalance of a rotating part comprising:
means for determining at least one parameter of the imbalance during a rotational movement of the rotating part which is a movement of the rotating part around an axis of rotation, the rotation of the rotating part also defining an axis of inertia of the rotating part; and
means for influencing the axis of rotation of the rotating part to improve the coincidence of the axis of rotation with the axis of inertia of the rotating part, means for influencing the axis of rotation of the rotating part effecting dynamic variation of the axis of rotation with respect to the axis of inertia of the rotating part in response to at least one parameter supplied as an input quantity to the means for influencing the axis of rotation of the rotating part.

20. The device according to claim 19, wherein the means for determining the imbalance determines at least one of a parameter relating to the extent of a deviation of the axis of rotation from the axis of inertia of the rotating part and a parameter relating to the direction of a deviation of the axis of rotation from the axis of inertia of the rotating part in a predetermined coordinate system and the thus-determined parameter is supplied as the at least one parameter to the means for influencing the axis of rotation of the rotating part.

21. The device according to claim 19, wherein the means for influencing the axis of rotation includes a plurality of actuators that can be triggered depending on the at least one parameter.

22. The device according to claim 21, wherein each of the plurality of actuators is triggered separately depending on the at least one parameter.

23. The device according to claim 21, wherein the means for influencing the axis of rotation of the rotating part includes at least two actuators.

24. The device according to claim 23, wherein the actuators are arranged in a plane that is spanned by a predetermined coordinate system.

25. The device according to claim 23, wherein the means for influencing the axis of rotation of the rotating part includes three or four actuators.

26. The device according to claim 21, wherein the actuators are configured to produce a linear movement.

27. The device according to claim 21, wherein the actuators include at least one transmission means each having two electrodes and a polymer electrically operatively connected thereto, in which a first section of the polymer can be deflected depending on an electric field generated by the two electrodes or the actuators are preferably spindles driven by an electric motor.

28. The device according to claim 27, wherein a second section of the polymer is provided with a support means that supports the conversion of electrical energy into mechanical energy of the polymer.

29. The device according to claim 19, wherein the rotating part is an electrically driven motor.

30. A dishwashing machine comprising
a washing container;
a device for washing crockery that has been disposed within the washing container, the device including at least one rotating part; and
means for determining at least one parameter of the imbalance during a rotational movement of the rotating part which is a movement of the rotating part around an axis of rotation, the rotating part also having an axis of inertia; and
means for influencing the axis of rotation of the rotating part to improve the coincidence of the axis of rotation with the axis of inertia of the rotating part, the means for influencing the axis of rotation of the rotating part effecting dynamic variation of the axis of rotation with respect to the axis of inertia of the rotating part in response to at least one parameter supplied as an input quantity to the means for influencing the axis of rotation of the rotating part.

31. The dishwashing machine according to claim 30, wherein the rotating part of the device is the drive motor of a circulating pump.

32. A method for damping the imbalance of a rotating part, the method comprising:
determining at least one parameter of the imbalance during a rotational movement of the rotating part;
determining at least one trigger value for a means for influencing the axis of rotation of the rotating part from the at least one parameter such that, in connection with a triggering of the means for influencing the axis of rotation of the rotating part, an improvement in the coincidence of the axis of rotation coincides with the axis of inertia of the rotating part is effected; and
supplying the at least one trigger value to the means for influencing the axis of rotation of the rotating part to bring about a dynamic variation of the axis of rotation of the rotating part and thereby effect an improvement in the coincidence of the axis of rotation coincides with the axis of inertia of the rotating part.

33. The method according to claim 32, wherein determining at least one parameter of the imbalance includes determining at least one of a parameter relating to the extent of a deviation of the axis of rotation from the axis of inertia of the rotating part and a parameter relating to the direction of a deviation of the axis of rotation from the axis of inertia of the rotating part in a predetermined coordinate system and the thus-determined parameter is supplied as the at least one parameter to the means for influencing the axis of rotation of the rotating part.

34. The method according to claim 32 and further comprising determining a voltage value from the at least one parameter value as a trigger value for the means for influencing the axis of rotation of the rotating part.

35. The method according to claim 34, wherein determining a voltage value from the at least one parameter value as a trigger value includes determining a separate voltage value for each of a plurality of actuators of the means for influencing the axis of rotation of the rotating part.

36. The method according to claim 35 and further comprising producing a deflection by an actuator as a function of the magnitude of the voltage values.
